(19) United States
(12) Patent Application Publication
(10) Pub. No.: US 2013/0021524 A1
(43) Pub. Date: Jan. 24, 2013

(54) UNIVERSAL MULTIPLE IMAGE PROCESSOR PLATFORM

(71) Applicant: Thomas W. Tang, Tigard, OR (US)

(72) Inventor: Thomas W. Tang, Tigard, OR (US)

(21) Appl. No.: 13/556,189

(22) Filed: Jul. 23, 2012

Related U.S. Application Data
(60) Provisional application No. 61/572,743, filed on Jul. 21, 2011.

(51) Int. Cl. H04N 7/04

(52) U.S. Cl. 348/469; 348/E07.04

(57) ABSTRACT

Multiple image processors, also known as a multiviewer or multiple input video wall processing is a device that allows multiple image inputs and combined them to form one or several outputs that consists of multiple images that can cross display boundaries. The invention provides a universal platform to allow multiple format input signals with unlimited expansion for number of inputs and unlimited expansion for number of outputs as well as unlimited expansion for resolutions. The different input sources can be from multimedia devices such as computers, DVD/Blu-ray players, and compressed IP streams as well as broadcast quality devices such as professional cameras or video servers. This universal platform allows the flexibility in multi-format configuration while provide real time throughput with minimal latency for video processing.

### CROSS-REFERENCE TO RELATED APPLICATIONS

This U.S. nonprovisional patent application claims benefit and priority under 35 U.S.C. §119(e) of the filing of U.S. provisional patent application No. 61/572,743 filed on Jul. 21, 2011, titled “UNIVERSAL MULTIPLE IMAGE PROCESSOR PLATFORM”, the contents of which are expressly incorporated herein by reference for all purposes as if fully set forth herein.

### BACKGROUND OF THE INVENTION

1. Field of the Invention

The present invention relates to systems and methods for tiling independent video windows on a larger video display. More particularly the invention is a multiple video format input platform and computer software application performing the layout and system configuration for a multiviewer display system.

2. Description of Related Art

Video displays for computers and television applications are well known. Such displays are generally used to display video or graphic images from a single source. For some applications it is useful to display more than one video image and other information on a single video display, e.g., multiple video windows tiled within a larger video display. Picture-in-picture (PIP) was an early application for such display technology that allowed a viewer to monitor the video from more than one channel at the same time on a single television display.

For other applications it is useful to be able to display many independent video windows and other graphic displays on a single high resolution video display, or on a multiple screen video wall that can cross display boundaries. Examples of such applications may include, but are not limited to, digital signage, video production facilities, master control and newsroom multi-image display processing and monitoring, sports bar video displays for concurrent display of live sporting events, multiple camera surveillance applications and gaming rooms at casinos for live sporting events.

Conventional systems provide limited mechanisms for displaying multiple formats of video signals by either requiring multiple monitors or multiple video processors with conversion equipment in between. One of the challenges in implementing such “multiviewers” is integrating various types or formats of video inputs for display on a single video display. This is a problem because there are many types and formats of video that may be displayed on a monitor, but each video input format may require specialized processing or hardware interfaces for display on a video monitor. Another challenge is to accommodate any number of such video inputs in a single system capable of display on a single screen multiviewer, or on a multiple screen video wall that can cross display boundaries. Thus, there exists a need in the art for a universal multiple image processor platform that attempts to address these challenges.

### BRIEF SUMMARY OF THE INVENTION

An embodiment of a universal multiple image processor platform is disclosed. The embodiment of the platform may include a universal receiver module (URM) adapted for receiving a plurality of video input signals. Each of the plurality of video input signals may independently have any one of a plurality of video signal formats as disclosed herein. The URM automatically decode each of the plurality of video input signals to determine the video signal format associated with each of the plurality of video input signals. The platform may further include a video processing module (VPM) in communication with the URM and adapted to receive each of the plurality of video input signals and the associated video formats. The VPM may be further adapted to scale each of the plurality of video input signals to generate a plurality of scaled video windows. Each of the plurality of scaled video windows may be adapted to fit a preselected window location within a video display. The VPM may be configured to generate a mixed video signal suitable for display on the video display, wherein each of the plurality of scaled video windows is displayed realtime in its preselected window location. The VPM may be further configured to output the mixed video signal for use on a video display.

An embodiment of a universal multiple image processor platform is disclosed. The platform may include a plurality of video processing units. Each video processing unit may include a universal receiver module (URM) adapted for receiving a plurality of video input signals. Each of the plurality of video input signals may independently have any one of a plurality of video signal formats. The URM may automatically decode each of the plurality of video input signals to determine the video signal format associated with each of the plurality of video input signals. Each video processing unit may further include a video processing module (VPM) in communication with the URM and adapted to receive each of the plurality of video input signals and the associated formats. The VPM may be further adapted to scale each of the plurality of video input signals to generate a plurality of scaled video windows. Each of the plurality of scaled video windows may be adapted to fit an associated preselected window location within a video display. The VPM may be configured to generate a mixed video signal suitable for display on the video display, wherein each of the plurality of scaled video windows is displayed realtime in its associated preselected window location. The VPM may be further configured to output the mixed video signal. The platform may further include a control processing module (CPM) in communication with each of the plurality of video processing units, the CPM adapted for controlling the platform through a computer network.

An embodiment of a method for displaying a plurality of video input signals on a plurality of window tiles of a video display is disclosed. The method may include receiving the plurality of video input signals. The method may include decoding each of the plurality of video input signals to determine a video signal format associated with each of the plurality of video input signals. The method may include processing each of the plurality of video input signals according to its associated video signal format. The method may include scaling each of the plurality of video input signals to fit a preselected video window resolution, thereby forming a plurality of scaled video windows. Method may further include selecting a unique tiling location for each of the plurality of scaled video windows on a video display. The method may include generating a mixed video signal from the plurality of scaled video windows. The method may include outputting the mixed video signal for display on a video display.

More details of the present invention will be presented in the following specification of the invention and the figures that will illustrate with examples and the principles of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a block diagram of a universal multiple image processor platform according to an embodiment of the present invention.

FIG. 2 illustrates an embodiment of a single board application consistent with the present invention.

FIG. 3 illustrates a block diagram of an embodiment of a control processing module according to the present invention.

FIG. 4 illustrates a block diagram of an embodiment of a front panel module according to the present invention.

FIG. 5 illustrates block diagrams of two embodiments of power supply modules according to the present invention.

FIG. 6 illustrates an embodiment of the multiple applications consistent with the present invention.

FIG. 7 illustrates an embodiment of cascading between multiple boards without a matrix, consistent with the present invention. In this example, VPM 1 & 2 are cascaded together, the 8 inputs are shown on output 2. With its input cascade disabled, VPM 3 will display as a quad for the 3^{rd} display.

FIG. 8 illustrates an embodiment of cascading between multiple boards with a matrix, consistent with the present invention.

FIG. 9 illustrates an embodiment of the cascading between multiple boards to form a hybrid system with broadcast and multimedia inputs, consistent with the present invention.

FIG. 10 illustrates an embodiment of multi-format audio inputs (analog, AES and embedded), consistent with the present invention.

In the following detailed description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring other aspects of the disclosure. Furthermore, the described features, structures, or characteristics may be combined in any suitable manner in one or more alternative embodiments according to the spirit and scope of the present invention.

### DETAILED DESCRIPTION OF THE INVENTION

The embodiments of the present invention provide an improved mechanism with a common platform to allow multiple different video formats to be displayed as a single screen multiviewer, or on a multiple screen video wall that can cross display boundaries. Thus, the present invention is an integrated multi-source and multi-window control and display system. In some examples, the techniques disclosed herein provide solutions for efficiently managing not only multiple input sources, but also multiple video input formats.

A common platform based on video processors can provide seamless migration from one format to another. Such a system may also allow the display of multiple video formats on or across one or more video displays or monitors. Windows within the displays can be freely adjusted, or placed two-dimensionally, by scaling and positioning.

Embodiments of the invention may include a common platform that may be expanded based on serial advanced technology attachment (SATA) 2 and 3 interface technologies. According to one embodiment of the present invention, an embedded controller may be connected to an unlimited number of video processors with the SATA 2 and 3 interfaces, which can form a monitor wall of virtually infinite size with virtually infinite resolution.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, an “embodiment” may be a system, a method, or a product of a process. The terms “multiviewer”, “multiview”, “video wall”, “video tiling” or “video wall processor” are used synonymously herein to refer to the integrated multi-source and multi-window control and display system and method of the present invention.

It will be understood that any of a wide variety of materials and manufacturing methods may be used to produce the various components of the presently described electrical, mechanical, and/or optical components disclosed herein. Such materials and manufacturing methods are within the knowledge of one of ordinary skill in the art and, therefore, will not be further elaborated herein.

The phrases “connected to,” “networked,” “coupled to,” and “in communication with” may refer to any form of interaction between two or more entities, including mechanical, electrical, magnetic, and electromagnetic interactions as may be recognized as contextually appropriate by one of skill in the art. Additionally, two components may be connected to each other even though they are not in direct physical contact with each other and even though there may be intermediary devices between the two components.

Some of the infrastructure that can be used with embodiments disclosed herein is already available or may be adapted for a particular application, such as: video processing and production equipment, general-purpose computers; computer programming tools and techniques; digital storage media; network and communication protocols, necessary power infrastructure, and the like.

In the following description, numerous details are provided to give a thorough understanding of various embodiments; however, the embodiments disclosed herein can be practiced without one or more of the specific details, or with other methods, components, materials, etc. In other instances, well-known structures, materials, or operations are not shown or described in detail to avoid obscuring aspects of this disclosure.

Display systems such as multiviewers and video walls receive video signals from various sources. Sources may include a computer, Blu-ray disc and DVD player, video camera, computer/video server and other broadcast quality video equipment. As you can imagine, there are many different video input formats and new formats being developed presently.

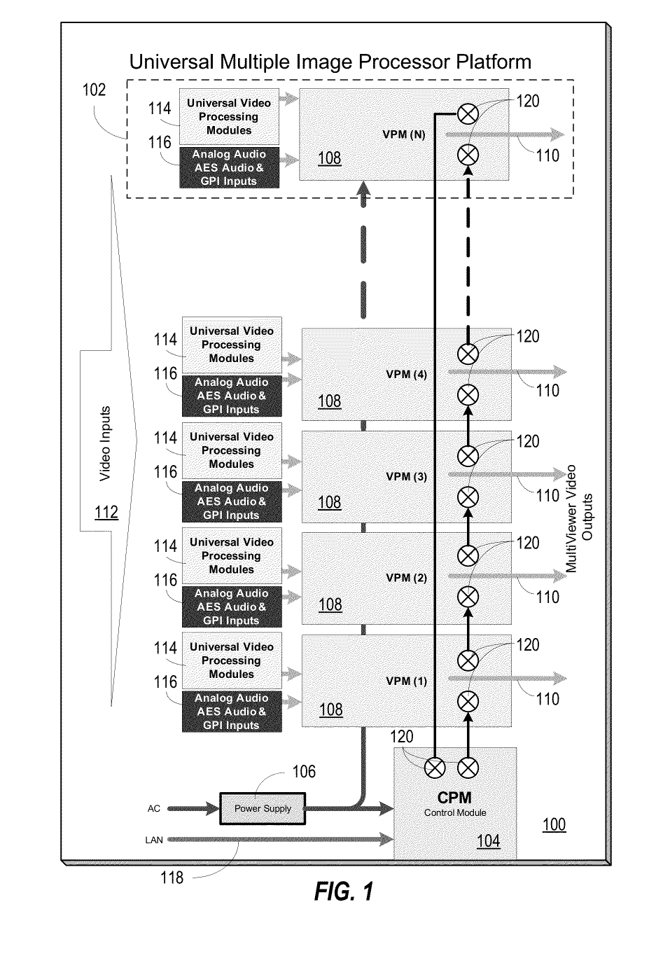

Reference will now be made to the drawing FIGS. in detail to some specific examples of the invention including the best modes of contemplated by the inventors for carrying out the invention. FIG. 1 is a block diagram of an embodiment of a universal multiple image processor platform 100 according to the present invention. Platform 100 displays multiple auto-detecting video inputs, each of which may have a unique input format, on any suitable high-resolution display (not shown in FIG. 1). For example and not by way of limitation, the high-resolution display may have resolution up to 2048×1080 pixels. Platform 100 combines the display of each of the video windows (generated from the video inputs), plus “on screen display” graphics, e.g., audio meters, labels, under monitor display (UMD), tallies, alarms and indicators in a very space efficient package. Depending on the model, embodiments of the present invention support auto-detecting of analog composite video, standard definition-serial data interface (SD-SDI), high definition-serial data interface (HD-SDI), high definition multimedia interface (HDMI), digital visual interface (DVI), video graphics array (VGA), component video, luminance (Y) and chrominance (C) (Y/C or S-video),green (Y) blue (Pb) red (Pr) component analog video signal (YPbPr) video.

Referring again to FIG. 1, platform 100 may include one or more (five shown, i.e., 1, 2, 3, 4 and N) video processing units 102 (see dashed box). According to various embodiments of platform 100, any number (N) of such video processing units 102 may be cascaded together to expand the number of video windows (not shown in FIG. 1) displayed using platform 100. Platform 100 may further include a control processing module (CPM) 104 in communication with, and configured to control, the video processing units 102. CPM 104 may have an Ethernet connection 118 (further labeled LAN, local area network) for network communications. Platform 100 may further include a power supply module (PSM) 106 (one shown) for conditioning input power and providing power to the video processing units and other electronics associated with platform 100.

As shown in FIG. 1, each video processing unit 102 may include a video processing module (VPM) 108 which generates a mixed video signal 110 (also labeled as “MultiViewer Video Outputs”) based on the video input signals 112 (see large arrow on left side). According to the embodiment illustrated in FIG. 1, the video input signals 112 may feed into a universal receiver module (URM) 114. There are various embodiments of URM 114 depending on the video input signal format and its physical connector, explained further below. The URM 114 decodes the input video signals to determine what type of video input signal format received and may perform some signal conditioning before passing the formatting information and video input signal to the VPM 108. The VPM 108 may also receive audio and general purpose inputs (GPI) directly, shown in blocks 116 labeled “Analog Audio (Audio Engineering Society) AES Audio & GPI Inputs”. Each of the VPMs 108 may be cascaded together to communicate over a SATA 2 or 3 interface, shown as circles with “X” inside 120. This cascading allows for expansion in the number of video inputs that may be received and the number of mixed video signals that may be output to a video display such as a multiviewer.

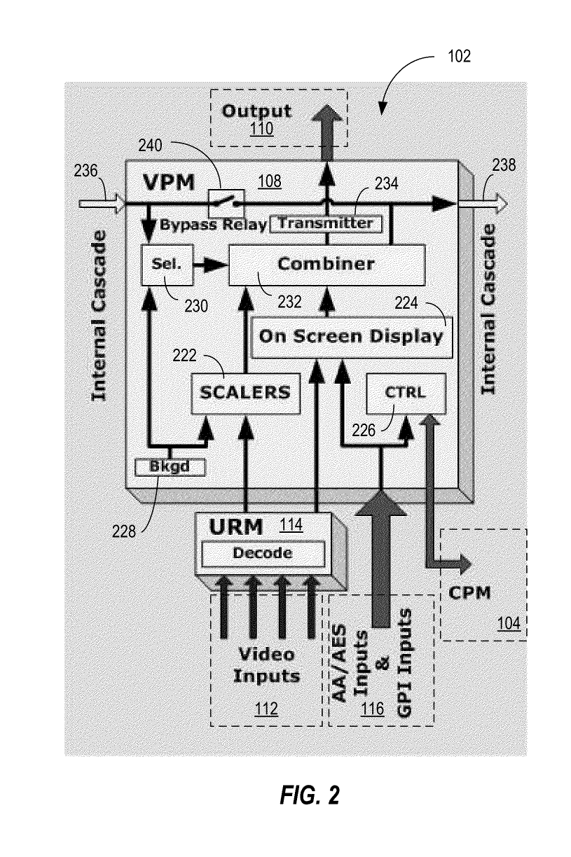

FIG. 2 is a block diagram of an embodiment of a video processing unit, shown generally at arrow 102. The embodiment of a video processing unit 102 includes a VPM 108 and a URM 114. FIG. 2 illustrates interconnections between the URM 114, VPM 108 and CPM 104 (dashed block). This particular embodiment of a URM 114 can accept up to four video sources (four video input signals 112) ranging from composite video to SD-SDI, HD-SDI and 3G-SDI video formats. One particular embodiment of a URM 114 may be configured with internal looping to accommodate the looping inputs in the SD-SDI, HD-SDI and 3G-SDI video formats.

The term “looping inputs” refers to an embodiment of a URM 114 that receives the SDI video input signal 112 through a cable equalizer (not shown), then the URM 114 splits the video input signal 112 into two video input signals 112A and 1128 (neither shown for simplicity of the drawings). The first video input signal 112A is forwarded to the VPM 108 for further processing. The second video input signal 1128 is processed through a reclocker (not shown) to make sure the signal 1128 is in good condition, then it goes to a cable driver (also not shown) so it can be sent out on a long cable run if necessary. Cable lengths for the looping inputs may be run as far as 400 meters for SD-SDI and up to 140 meters for HD-SDI.

The embodiment of a VPM 108 shown in FIG. 2 includes a scaler block 222 that performs the scaling of the video input signal 112 received from URM 114. The scaler block 222 shrinks the original resolution of the video input signal 112 down to a particular video window resolution for later combining and display. VPM 108 further includes an on screen display block 224 that generates graphics associated with the video windows, e.g., audio meters, labels, under monitor display (UMD), tallies, alarms, indicators and the like. The on screen display 224 receives input from the URM 114 and from the analog audio (AA)/AES audio inputs and from the GPI inputs, shown in dashed block 116. Block 116 also feeds a control block 226 that in turn interfaces with the CPM 104. It will be understood that any type of embedded processor could be used to implement control block 226. VPM 108 further includes a background generator 228 in communication with the scaler block 222 and selector block 230. The background generator 228 graphically constructs a background upon which the video windows are tiled. The background may be black according to one embodiment. The selector block 230 may also receive serialized video data from an input SATA 2 or 3 interface of the input cascade 236 between VPMs in expansion configuration. The selector block 230 may forward that serialized video data to the combiner 232 that also receives the video windows from the on screen display 224. The combiner 232 combines the video windows including video cascaded from a prior VPM via the selector block 230 and on screen display 224 graphics and outputs to a transmitter 234 that outputs the mixed video signal 110 for display. The combiner 232 also cascades the mixed video signal 110 to an output cascade 238 on the internal cascade (right side of FIG. 2). The cascading of video data from one VPM 108 to another VPM 108 may be directly bypassed via bypass relay 240.

The VPM 108 can process and scale up to 4 independent video inputs 112. The VPM 108 may also be configured with an onboard full color 2D graphics engine (not shown) that inserts graphical “on screen display” elements such as borders, clocks, labels and meters. According to one embodiment of platform 100, an onboard microprocessor accepts up to eight general purpose inputs (GPI) for tally/counter, control and analog and AES audio inputs.

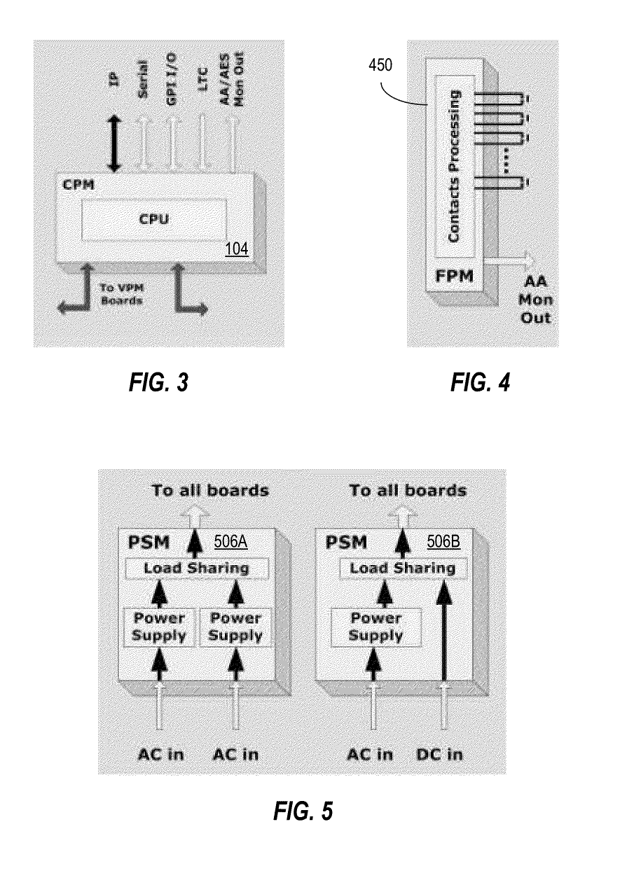

FIGS. 3-5 are block diagrams of the CPM 104, front panel module (FPM) and PSM components, respectively, of a multi-module, single board embodiment of platform 100 consistent with the present invention. FIGS. 3-5 are diagrammatic representations showing how the CPM 104, FPM 450, and PSM 106 (506A and 506B) are interconnected with other components of platform 100. The CPM 104 manages the serial, IP, control, GPI, longitudinal time code and analog and AES audio monitoring outputs. The FPM 450 handles the front panel buttons, contact processing, status LEDs and front panel analog audio monitoring and adjustment. The PSM (Power Supply Module) has two load sharing redundant power supplies 506A and 506B.

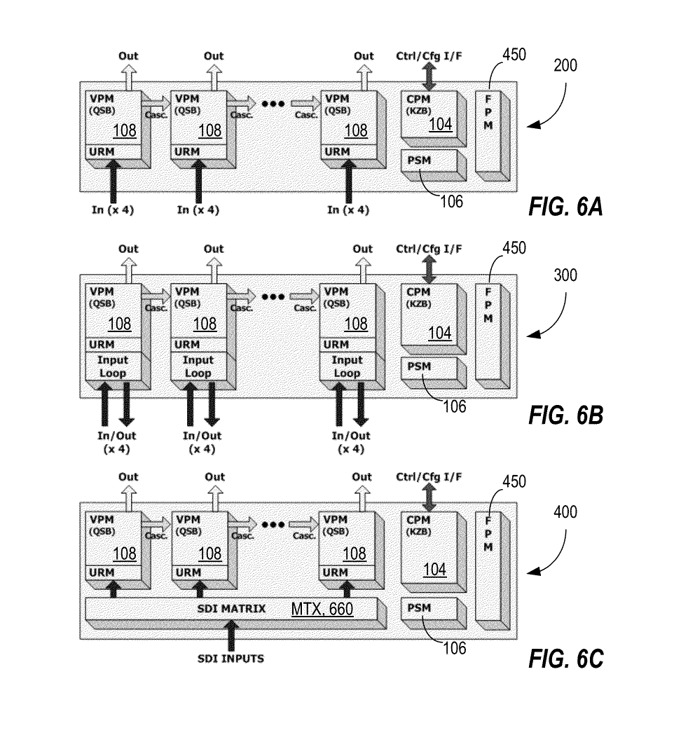

FIGS. 6A-6C are a diagrammatic representations showing different implementations of platform 100, namely platforms 200, 300 and 400, with different mixes or embodiments of URM 114 and SDI matrix board (MTX) 660 components. Note that common with each of platforms 200, 300 and 400 are cascaded VPMs 108, a CPM 104, FPM 450 and PSM 106. The variation is in the front end signal processing with various configurations of URM.

More particularly, FIG. 6A illustrates an embodiment of a platform 200 with four video inputs (see In(x4)) being fed into the URM 114 before passing to the VPM 108. Cascading for expansion occurs to the right. FIG. 6B illustrates another embodiment of a platform 300, wherein the URM is configured with input looping as described herein. Thus, each URM accepts four video input signals and splits the input signals within the URM 114 to go to the VPM and then also back out (see In/Out (x4)). FIG. 6C illustrates yet another embodiment of a platform 400, wherein the SDI video inputs are first run through the MTX 660, that allows any input source to go to any output (window). The MTX 660 also allows the input video signal to be duplicated. Thus, the MTX 660 allows any input to be switched to any output and any input to multiple outputs if desired.

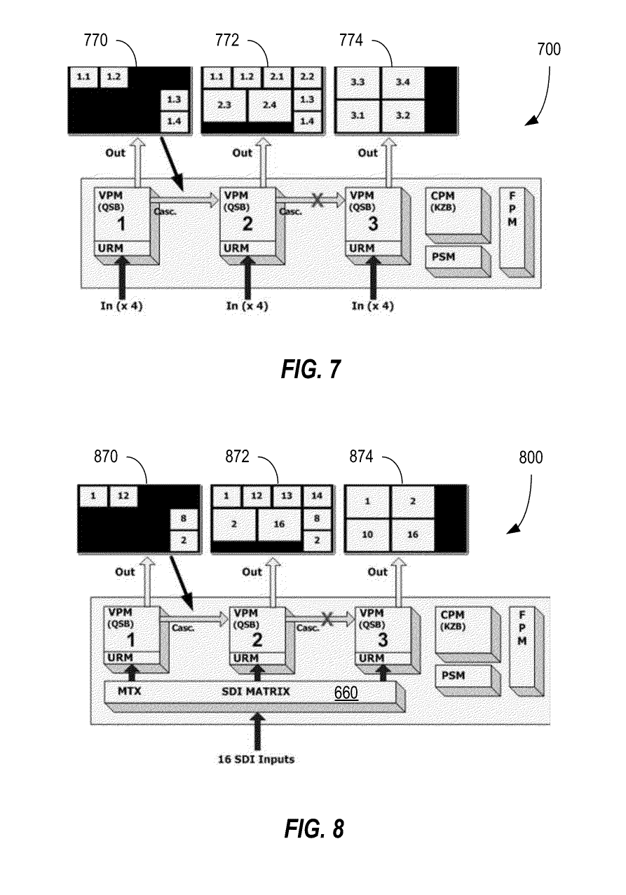

FIG. 7 is a diagrammatic representation showing how multiple VPMs can be cascaded together using the SATA 2/3 technology to increase the number of inputs. More particularly, FIG. 7 illustrates a platform 700 similar to platform 200 (FIG. 6A) showing exemplary mixed video signals that may be generated at each stage of the cascading of the VPMs as they would be graphically illustrated if displayed on a video display. For example, the mixed video signal from VPM 1 shows four video windows 1.1, 1.2, 1.3 and 1.4 as they would be displayed on video display 770. Whereas the mixed video signals from VPM 2, as they would be displayed on video display 772, shows the eight video windows including the four video windows 1.1, 1.2, 1.3 and 1.4 from VPM 1 and the additional four video windows 2.1, 2.2, 2.3, and 2.4 from VPM 2. Finally, FIG. 7 illustrates the use of the bypass relay (not shown, but represented as an “X” on the final cascade to VPM 3). The mixed video signal from VPM 3 only includes the four video windows 3.1, 3.2, 3.3, and 3.4 processed by VPM 3, as they would be displayed on video display 774.

FIG. 8 is a diagrammatic representation showing how multiple VPMs can be cascaded together using the SATA 2/3 technology to increase the number of inputs while using a MTX board 660 prior to the URM to allow any input to be switched to any output. In essence, the MTX board 660 operates as a multiplexor for the sixteen SDI video inputs (1-16). More particularly, FIG. 8 illustrates a platform 800 similar to platform 500 (FIG. 6C) showing exemplary mixed video signals that may be generated at each stage of the cascading of the VPMs as they would be graphically illustrated if displayed on a video display. For example, the mixed video signal from VPM 1 shows four video windows 1, 2, 8 and 12 as they would be displayed on video display 870. Whereas the mixed video signals from VPM 2, as they would be displayed on video display 872, shows the eight video windows including the four video windows 1, 2, 8 and 12 from VPM 1 and the additional four video windows 2, 13, 14 and 16 from VPM 2. Note that window 2 has been duplicated and is a different size, based on that input being matrixed into VPM 1 and VPM 2 by the MTX 660. Finally, FIG. 8 again illustrates the use of the bypass relay (not shown, but represented as an “X” on the final cascade to VPM 3). The mixed video signal from VPM 3 only includes the four video windows 1, 2, 10 and 16 processed by VPM 3, as they would be displayed on video display 874.

According to one embodiment of platform 100, the cascading architecture employs SATA 2/3 technology. According to a particular embodiment of platform 100, each VPM 108 accepts up to 4 video inputs, sizes them and “keys” them, over a black background. Each VPM has the ability to accept the output of an upstream VPM via the SATA interface, effectively providing the downstream output as its background. Regardless how many inputs or number of VPMs are cascaded, the maximum processing delay is 1 frame for the cascading architecture, according to a presently preferred embodiment.

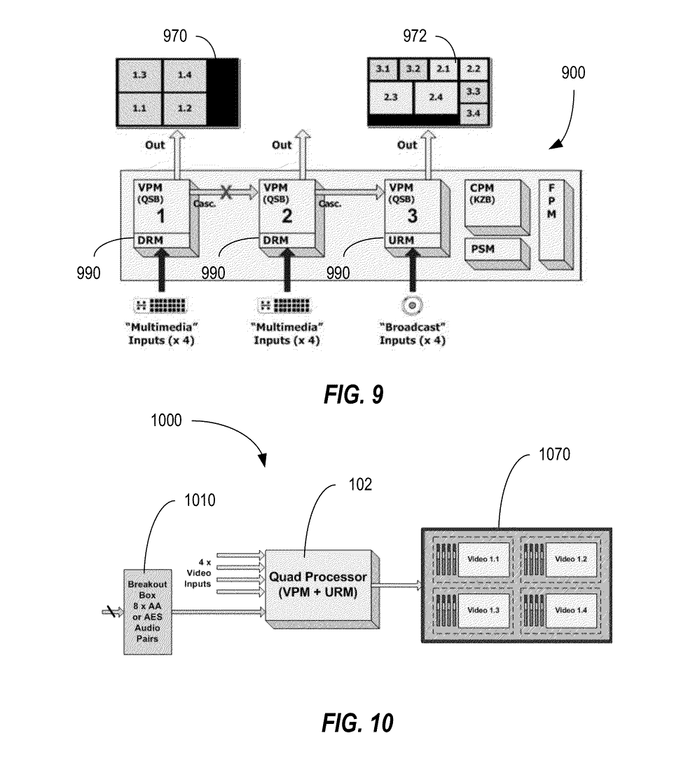

FIG. 9 is a diagrammatic representation showing an embodiment of a hybrid format platform 900 illustrating multiple VPM's cascaded together using the SATA 2/3 technology as in other platform embodiments while using data receiving module (DRM) 990 instead of the URM 114 discussed above. The DRM 990 may be configured to receive multimedia video inputs, such as HDMI, DVI and broadcast digital video formats. The video display 970 displays the four multimedia inputs fed into the first DRM 990 associated with VPM 1 as video windows 1.1, 1.2, 1.3 and 1.4. These video windows are not cascaded to VPM 2 which generates video windows 2.1, 2.2, 2.3, and 2.4 which have been combined by cascading to VPM 3. Thus, video display 972 driven by VPM 3 displays the eight video windows generated by VPM 2 and VPM 3, namely, video windows 2.1, 2.2, 2.3, 2.4, and broadcast video input windows 3.1, 3.2, 3.3 and 3.4. From the examples shown in FIGS. 7-9, the incredible flexibility of the universal multiple image processor platform becomes clear.

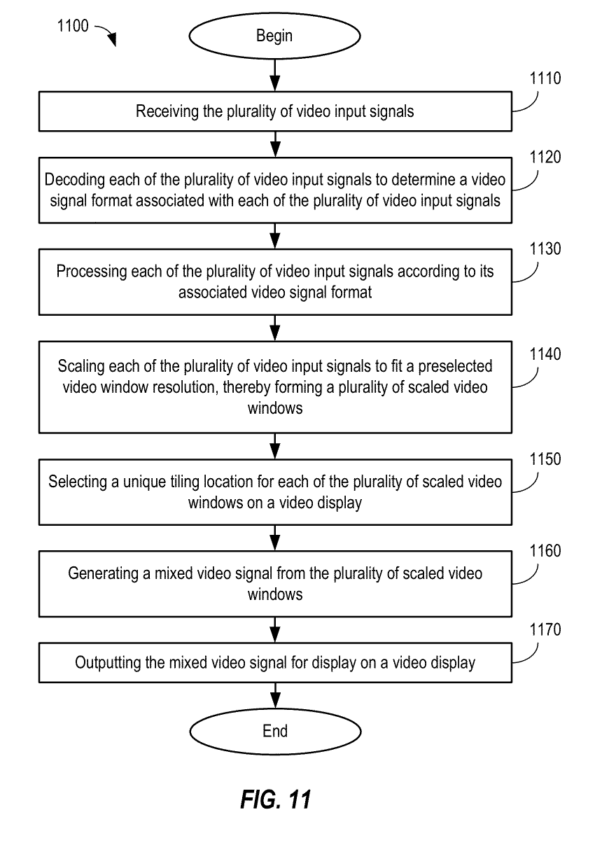

FIG. 10 illustrates an embodiment of a system 1000 including a video processing unit 102 (Quad Processor, VPM +URM) input with four video input signals 112 and an audio breakout box 1010 having multi-format audio inputs (analog, AES and embedded), consistent with the present invention. The output from the video processing unit 102 is shown on video display 1070 to include video windows 1.1, 1.2, 1.3, 1.4 and, e.g., graphic on screen display information such as audio meters.

Referring again generally to FIG. 1, each video input on platform 100 accepts 16 channels of SDI embedded audio, 8 channels of embedded HDMI embedded audio, 4 channels of analog or AES discrete audio. Each video input on platform 100 can display up to 16 audio meters. The audio meters can be placed over or outside the video windows. The following are additional general embodiments of the invention without specific reference to the drawing FIGS. according to the present invention.

Another embodiment of a universal multiple image processor platform 100 is disclosed. Platform 100 may include a universal receiver module (URM) 114 adapted for receiving a plurality of video input signals 112. According to this embodiment of platform 100, each of the plurality of video input signals may independently have any one of the plurality of video signal formats disclosed herein. According to this embodiment of platform 100, the URM 114 may automatically decode each one of the plurality of video input signals to determine its associated video signal format.

Further according to this embodiment of platform 100, each of the associated video formats may be one of the following types/formats for video signals: serial data interface (SDI), composite video, high definition multimedia interface (HDMI), digital visual interface (DVI), video graphics array (VGA), green (Y) blue (Pb) red (Pr) component analog video signal (YPbPr), luminance (Y) and chrominance (C) (Y/C or S-video), asynchronous serial interface (ASI), motion picture experts group (MPEG) MPEG-2, and advanced video coding (AVC) H.264/MPEG-4. Of course, it will be understood that any video processing standard, codec, format or type, not just those listed herein and consistent with the spirit and scope of the invention may be used with the inventive platform 100 disclosed herein.

This embodiment of platform 100 may further include a video processing module (VPM) 108 in communication with the URM 114 and adapted to receive each of the plurality of video input signals and the associated formats. This embodiment of the VPM 108 may be adapted to scale each of the plurality of video input signals to generate a plurality of scaled video windows. Each of the plurality of scaled video windows adapted or configured to fit a preselected window location within a video display. According to this embodiment, VPM 108 is configured to generate a mixed video output signal suitable for display on the video display. According to this embodiment, each of the plurality of scaled video windows may be displayed realtime in its preselected window location. According to this embodiment, VPM 108 is configured output the mixed video signal 110. The mixed video signal 110 may be displayed on a single high resolution video display, or on a multiple screen video wall that can cross display boundaries. According to yet another embodiment of platform 100, the mixed video signal 110 may be HDMI, DVI or SDI video format.

According to another embodiment, platform 100 may further include a control processing module (CPM) 104 in communication with the VPM 108 adapted for controlling the platform 100.

According to another embodiment of platform 100, the VPM 108 may be further adapted to selectively serialize and deserialize each of the plurality of video input signals. According to one embodiment of platform 100, the VPM 108 may be further adapted to send serialized video data to, and receive serialized video data from, other VPMs. Thus, serialized video signals may be passed from one VPM 108 to another cascaded VPM 108 for further combining, processing and display. According to one embodiment of platform 100, a communications interface 120 between the VPM 108 and the other VPMs 108 may be either serial advanced technology attachment (SATA) 2 or SATA 3.

According to yet another embodiment of platform 100, the VPM 108 may be further adapted to receive and process audio signals and general purpose input signals 116. According to still another embodiment of platform 100, the VPM 108 may be further adapted to generate preselected on screen display information (OSD) for display along with the plurality of scaled video windows. The OSD may include one or more labels, borders, clocks, audio meters and logos, according to various embodiments of platform 100.

Another embodiment of a universal multiple image processor platform 100 is disclosed. This embodiment of platform 100 may include a plurality of video processing units 102. According to this embodiment of platform 100, each video processing unit 102 may include a URM 114 adapted for receiving a plurality of video input signals 112. According to this embodiment of platform 100, each of the plurality of video input signals 112 may independently have any one of a plurality of video signal formats, such as those disclosed herein. According to this embodiment of platform 100, the URM 114 automatically decodes each of the plurality of video input signals 112 to determine the video signal format associated with each of the plurality of video input signals 112. and

According to this embodiment of platform 100, each video processing unit 102 may further include a VPM 108 in communication with the URM 114. According to this embodiment, VPM 108 may be adapted to receive each of the plurality of video input signals 112 and the associated formats from the URM 114. According to this embodiment, VPM 108 may be further adapted to scale each of the plurality of video input signals 112 to generate a plurality of scaled video windows. Each of the plurality of scaled video windows may be adapted to fit an associated preselected window location within a video display. According to this embodiment of platform 100, VPM 108 may generate a mixed video signal 110 suitable for display on the video display. According to this embodiment, each of the plurality of scaled video windows may be displayed realtime in its associated preselected window location. According to this embodiment of platform 100, VPM 108 may output the mixed video signal 110. According to this embodiment, platform 100 may further include a CPM 104 in communication with each of the plurality of video processing units 102. According to this embodiment, the CPM 104 may be adapted for controlling the platform 100 through a computer network, e.g., a local area network (LAN) or Ethernet.

According to another embodiment of platform 100, each of the plurality of video processing units 102 may further be adapted to send serialized video data to, and receive serialized video data from, each other. According to a particular embodiment of platform 100, each of the plurality of video processing units 102 may further be adapted to send serialized video data to, and receive serialized video data from, each other over a SATA 2 or 3 interfaces.

According to another embodiment of platform 100, the CPM 104 may be an internet protocol (IP) network device assigned a unique IP address. By assigning a unique IP address to the CPM 104 of platform 100, multiple platforms 100 can be accessed via a IP network. According to another embodiment of platform 100, control software can be used to connect to the CPM 104 via TCP/IP to control and configure the layout of the multiple windows to be displayed. According to yet another embodiment of platform 100, the CPM 104 may include its own native communications protocol to facilitate communication of 3rd party software.

According to another embodiment of platform 100, the mixed video signal 110 output by VPM 108 may have one of the following video formats: high definition multimedia interface (HDMI), digital visual interface (DVI) and serial data interface (SDI). According to yet the associated video formats which may be accepted by the URM 114 include, but are not limited to: serial data interface (SDI), composite video, high definition multimedia interface (HDMI), digital visual interface (DVI), video graphics array (VGA), green (Y) blue (Pb) red (Pr) component analog video signal (YPbPr), luminance (Y) and chrominance (C) (Y/C or S-video), asynchronous serial interface (ASI), motion picture experts group (MPEG) MPEG-2, and advanced video coding (AVC) H.264/MPEG-4. It will be understood that the principles of the disclosed invention are capable of being applied to any existing video format, standard, codec or type and any such video formats that may occur in the future.

According to another embodiment, platform 100 may include an embedded CPM 104 with at least one VPM 108. According to this embodiment, SATA 2 and 3 cables and electrical interfaces are used for both high speed and low speed transport between the CPM 104 and the VPM 108. Each VPM 108 may have its own mixed video signal that can be output to drive a compatible display device. When more than one VPM 108 is combined by cascading serial video data through SATA 2 or 3 interfaces, the number of video windows that can be displayed expands accordingly. Additionally, using the SATA 2 or 3 interfaces between VPMs 108 allows for virtually unlimited expansion and flexibility.

According to another embodiment of platform 100, the video input signals 112 may be compressed internet protocol (IP) streams. According to yet another embodiment of platform 100, the video input signals 112 may be in HDMI format versions, 1.1, 1.2 and/or 1.3. According to still another embodiment of platform 100, the video input signals 112 may be in SDI video format, including, HD-SDI, SD-SDI and 3G HD-SDI video formats. Furthermore, according to another embodiment of platform 100, the HDMI and DVI mixed video signal 110 can be output through an RJ45 physical connector. According to yet another embodiment of platform 100, the output HDMI and DVI mixed video signals can be single mode or multi-mode fiber using SC, LC or ST termination. According to yet another embodiment of platform 100, the SDI mixed video signal output can be single mode or multi-mode fiber using ST termination. According to still another embodiment of platform 100, the VPM 108 can display multiple video windows on one video display, multiple displays and across one or more displays.

FIG. 11 is a flowchart of an embodiment of a method for displaying a plurality of video input signals on a plurality of window tiles of a video display 1100 consistent with the present invention. Method 1100 may further include receiving the plurality of video input signals 1110. Method 1100 may further include decoding each of the plurality of video input signals to determine a video signal format associated with each of the plurality of video input signals 1120. Method 1100 may further include processing each of the plurality of video input signals according to its associated video signal format 1130. Method 1100 may further include scaling each of the plurality of video input signals to fit a preselected video window resolution, thereby forming a plurality of scaled video windows 1140. Method 1100 may further include selecting a unique tiling location for each of the plurality of scaled video windows on a video display 1150. Method 1100 may further include generating a mixed video signal from the plurality of scaled video windows 1160. Method 1100 may further include outputting the mixed video signal for display on a video display 1170.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

What is claimed is:

1. A universal multiple image processor platform, comprising:
a universal receiver module (URM) adapted for receiving a plurality of video input signals, each of the plurality of video input signals independently having any one of a plurality of video signal formats, the URM automatically decoding each of the plurality of video input signals to determine the video signal format associated with each of the plurality of video input signals, wherein each of the associated video formats is selected from the group consisting of:
serial data interface (SDI),
composite video,
high definition multimedia interface (HDMI),
digital visual interface (DVI),
video graphics array (VGA),
green (Y) blue (Pb) red (Pr) component analog video signal (YPbPr),
luminance (Y) and chrominance (C) (YC or S-video),
asynchronous serial interface (ASI),
motion picture experts group (MPEG) MPEG-2, and
advanced video coding (AVC) H.264/MPEG-4; and
a video processing module (VPM) in communication with the URM and adapted to receive each of the plurality of video input signals and the associated video formats, the VPM further adapted to scale each of the plurality of video input signals to generate a plurality of scaled video windows, each of the plurality of scaled video windows adapted to fit a preselected window location within a video display, the VPM generating a mixed video signal suitable for display on the video display, wherein each of the plurality of scaled video windows is displayed realtime in its preselected window location and the VPM outputting the mixed video signal.

2. The universal multiple image processor platform according to claim 1, further comprising a control processing module (CPM) in communication with the VPM adapted for controlling the platform.

3. The universal multiple image processor platform according to claim 1, wherein the VPM is further adapted to selectively serialize and deserialize each of the plurality of video input signals.

4. The universal multiple image processor platform according to claim 1, wherein the VPM is further adapted to receive and process audio signals and general purpose input signals.

5. The universal multiple image processor platform according to claim 1, wherein the VPM is further adapted to generate preselected on screen display information (OSD) for display along with the plurality of scaled video windows, the OSD comprising at least one of: labels, borders, clocks, audio meters and logos.

6. The universal multiple image processor platform according to claim 1, wherein the VPM is further adapted to send serialized video data to, and receive serialized video data from, other VPMs.

7. The universal multiple image processor platform according to claim 6, wherein a communications interface between the VPM and the other VPMs comprises either serial advanced technology attachment (SATA) 2 or SATA 3.

8. The universal multiple image processor platform according to claim 1, wherein the mixed video signal comprises a video format selected from the group consisting of: HDMI, DVI and SDI.

9. A universal multiple image processor platform, comprising:
a plurality of video processing units, each video processing unit, comprising:
a universal receiver module (URM) adapted for receiving a plurality of video input signals, each of the plurality of video input signals independently having any one of a plurality of video signal formats, the URM automatically decoding each of the plurality of video input signals to determine the video signal format associated with each of the plurality of video input signals; and
a video processing module (VPM) in communication with the URM and adapted to receive each of the plurality of video input signals and the associated formats, the VPM further adapted to scale each of the plurality of video input signals to generate a plurality of scaled video windows, each of the plurality of scaled video windows adapted to fit an associated preselected window location within a video display, the VPM generating a mixed video signal suitable for display on the video display, wherein each of the plurality of scaled video windows is displayed realtime in its associated preselected window location, and the VPM further outputting the mixed video signal; and
a control processing module (CPM) in communication with each of the plurality of video processing units, the CPM adapted for controlling the platform through a computer network.

10. The universal multiple image processor platform according to claim 9, wherein each of the plurality of video processing units is further adapted to send serialized video data to, and receive serialized video data from, each other.

11. The universal multiple image processor platform according to claim 9, wherein each of the plurality of video processing units is further adapted to send serialized video data to, and receive serialized video data from, each other over a serial advanced technology attachment (SATA) 2 or 3 bus.

12. The universal multiple image processor platform according to claim 9, wherein the GPM further comprises an internet protocol (IP) network device assigned a unique IP address.

13. The universal multiple image processor platform according to claim 9, wherein the mixed video signal output by the VPM comprises a video format selected from the group consisting of: high definition multimedia interface (HDMI), digital visual interface (DVI) and serial data interface (SDI).

14. The universal multiple image processor platform according to claim 9, wherein each of the associated video formats is selected from the group consisting of:
serial data interface (SDI),
composite video,
high definition multimedia interface (HDMI),
digital visual interface (DVI),
video graphics array (VGA),
green (Y) blue (Pb) red (Pr) component analog video signal (YPbPr),
luminance (Y) and chrominance (C) (Y/C or S-video),
asynchronous serial interface (ASI),
motion picture experts group (MPEG) MPEG-2, and
advanced video coding (AVC) H.264/MPEG-4.

15. A method for displaying a plurality of video input signals on a plurality of window tiles of a video display, the method comprising:
receiving the plurality of video input signals;
decoding each of the plurality of video input signals to determine a video signal format associated with each of the plurality of video input signals;
processing each of the plurality of video input signals according to its associated video signal format;
scaling each of the plurality of video input signals to fit a preselected video window resolution, thereby forming a plurality of scaled video windows;
selecting a unique tiling location for each of the plurality of scaled video windows on a video display;
generating a mixed video signal from the plurality of scaled video windows; and
outputting the mixed video signal for display on a video display.
